(19) United States
(12) Patent Application Publication
(10) Pub. No.: US 2018/0065497 A1
(43) Pub. Date: Mar. 8, 2018

(54) Emergency Driving Mode for an Electric Vehicle

(71) Applicant: Bayerische Motoren Werke Aktiengesellschaft, Muenchen (DE)

(72) Inventor: Reiner PFEIFER, Muenchen (DE)

(21) Appl. No.: 15/806,470

(22) Filed: Nov. 8, 2017

Related U.S. Application Data
(63) Continuation of application No. PCT/EP2016/062222, filed on May 31, 2016.

(30) Foreign Application Priority Data
Jul. 8, 2015 (DE) 10 2015 212 718.4

(51) Int. Cl. B60L 11/18; H01M 10/42

(52) U.S. Cl. CPC B60L 11/1851; H01M 10/42; H01M 2220/20; B60L 2240/54; B60L 2250/12

(57) ABSTRACT

A method is provided for increasing the range of an electric vehicle, in particular an electric scooter, having an electric motor, at least one storage cell, and a controller for the electric motor. The method includes the following steps: a) initiation of the activation of a residual capacity of the storage cell by the operator, wherein the use of the residual capacity is blocked by the controller during normal driving operation, and b) unlocking the residual capacity. The electric vehicle, in particular the electric scooter, can be operated according to the corresponding method.

### CROSS REFERENCE TO RELATED APPLICATIONS

This application is a continuation of PCT International Application No. PCT/EP2016/062222, filed May 31, 2016, which claims priority under 35 U.S.C. §119 from German Patent Application No. 10 2015 212 718.4, filed Jul. 8, 2015, the entire disclosures of which are herein expressly incorporated by reference.

### BACKGROUND AND SUMMARY OF THE INVENTION

The invention relates to an electric vehicle and a method for increasing the range of an electric vehicle.

Electric vehicles, in particular electric scooters, with electric motors that are supplied with energy from storage cells are known and are valued because of their low harmful emissions and low noise emissions thereof.

The disadvantage of the vehicles is that, compared to vehicles with a combustion engine, they only have a small range and also cannot be charged up rapidly. A fallback level, analogous to the reserve tanks in vehicles with a combustion engine, is not available.

In the event of the battery capacity having been consumed, the electric vehicle must come to a standstill. This circumstance is not only not very pleasant for the user of the electric vehicle, but can also lead to emergency situations or can exacerbate such situations if the user is already in an emergency situation.

It is the object of the invention to provide an electric vehicle and a method for an electric vehicle that enables the range of the electric vehicle to be increased in emergency situations.

To achieve the object, a method is provided for increasing the range of an electric vehicle, in particular an electric scooter, with an electric motor, at least one storage cell, and a controller for the electric motor. The method includes the following steps:

a) initiating the activation of a residual capacity of the storage cell by the operator, wherein the use of the residual capacity is blocked by the controller in the normal driving mode; and
b) unlocking the residual capacity.

In order to protect the storage cells and to avoid damage that reduces the capacity or the performance of the storage cells, according to the prior art only about 90% of the energy available in the storage cells is used. This means that in normal use the storage cells are never fully discharged, because the use of the storage cells at an energy level of about 10% is blocked by the controller and is only unlocked again after recharging. However, this residual capacity can be used to deal with an emergency situation, in particular if the possible damage to the storage cell can be neglected compared to the opportunity costs of the emergency situation. The method according to the invention enables the use of the residual capacity and thus results in improved safety.

Preferably, the activation of the residual capacity is initiated in the step a) by the input of an activation code, in particular by entering a key combination. In this way, the unintentional activation and use of the residual capacity and related possible damage to the storage cells can be excluded.

The method preferably also includes the following step between the steps a) and b):

c) confirm the activation of the residual capacity by the operator.

As the operator must confirm the activation of the residual capacity in a further step, an additional safeguard is provided, which prevents the unintentional activation of the residual capacity.

According to an advantageous embodiment, the method also comprises the following step between the steps a) and c):

d) the output of an indication to the operator by the electric vehicle that the activation of the residual capacity can damage the storage cell.

This step enables the operator to be made aware of the possible consequences of activation of the residual capacity, and enables the vehicle manufacturer to be additionally protected against claims for damages.

According to a further advantageous embodiment, the method additionally comprises the following step between the steps a) and c):

e) the output of an indication to the operator by the electric vehicle that the activation of the residual capacity is logged in a memory and can be read out by customer services.

With this indication, the operator is additionally warned about misuse and, moreover, is informed that the activation of the residual capacity is recorded.

The method preferably additionally comprises the following step:

f) logging the activation of the residual capacity in a memory.

As a result of this, every activation of the residual capacity is stored and enables customer services to identify and carry out any necessary measures, for example.

By the activation of the residual capacity, even full discharge of the at least one storage cell is possible. In this way, the maximum available amount of energy is available.

Alternatively, it is possible to define a lower limit within the residual capacity, below which the storage cell cannot be emptied further.

According to the invention, to achieve the aforementioned object, an electric vehicle, in particular an electric scooter, having an electric motor and at least one storage cell, is provided. The residual capacity of the at least one storage cell can be unlocked by a method. A controller for the electric motor blocks the use of the residual capacity of the storage cell in the normal driving mode. There is an input device that is coupled to the controller, wherein on actuating the input device the controller unlocks the use of the residual capacity. The input device can be part of the devices provided for operating the electric vehicle. However, an extra input device is possible, which specifically includes the activation of the residual capacity.

The controller is preferably implemented so that the use of the residual capacity enables complete discharging of the storage cell and not only a part of the residual capacity. Thus, the entire amount of energy present can be used.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic drawing of an electric vehicle according to an embodiment of the invention.

FIG. 2 is a diagram of the method according to an embodiment of the invention.

### DETAILED DESCRIPTION OF THE DRAWINGS

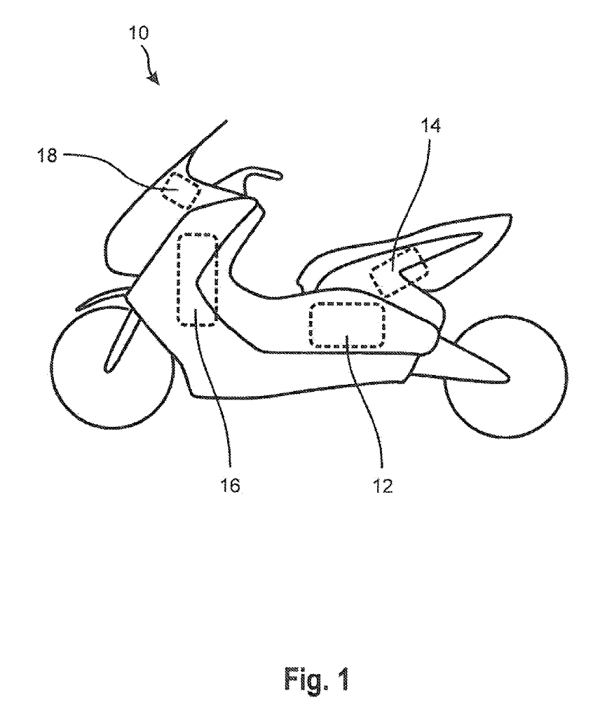

An electric vehicle 10 is shown in FIG. 1. The electric vehicle 10 has an electric motor 12 and at least one storage cell 14 for storing electrical energy. A controller 16 controls the motor 12 and is coupled to the storage cell 14. A throttle grip is coupled to the controller 16, so that the controller 16 converts the signal from the throttle grip into a flow of energy out of the storage cell 14.

However, in the normal driving mode the controller 16 blocks a further flow of energy once a predetermined residual capacity of the storage cell 14, for example 10%, is reached, i.e. before the storage cell 14 is completely discharged.

An energy discharge device 18 to be operated by the driver is coupled to the controller 16.

Using a method, the residual capacity of the storage cell 14 can be unlocked.

For this purpose, the use of the residual capacity must be activated by means of the input device 18, whereupon the controller 16 unlocks the use of the residual capacity.

In this case, the controller 16 can be implemented so that the use of the residual capacity enables complete discharging of the storage cell 14.

However, the method is not limited to electric vehicles with one storage cell 14, but can also be used in a (not represented) embodiment to unlock the residual capacity of an electric vehicle 10 with a plurality of storage cells 14.

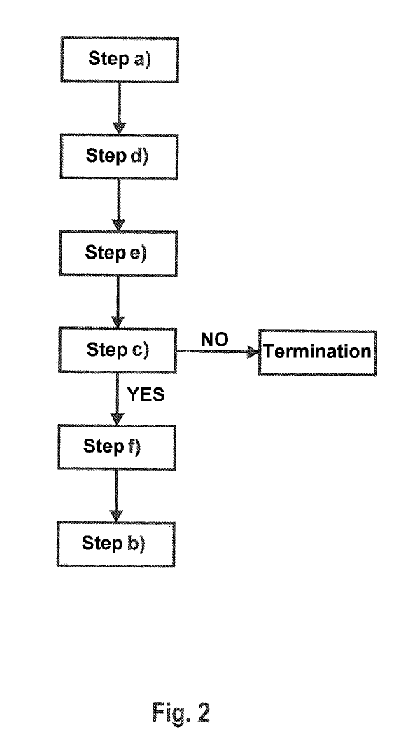

In FIG. 2, the method for increasing the range of an electric vehicle 10 with an electric motor 12, at least one storage cell 14 and a controller 16 for the electric motor 12 is shown. The method comprises the following steps:

a) initiating the activation of a residual capacity of the storage cell 14 by the operator, wherein the use of the residual capacity is blocked in the normal driving mode by the controller 16;
b) unlocking the residual capacity;
c) confirming the activation of the residual capacity by the operator;
d) outputting an indication to the operator by the electric vehicle 10 that the activation of the residual capacity of the storage cell 14 can cause damage;
e) outputting an indication to the operator by the electric vehicle 10 that the activation of the residual capacity is logged in a memory and can be read out by customer services; and

f) logging the activation of the residual capacity in a memory.

These steps can be combined with each other in the manner represented in the process diagram.

The activation of the residual capacity in step a) can be initiated by the input of an activation code. In particular, this can be carried out by entering a key combination.

In order to prevent damage to the storage cell(s), it is thus possible that following a predetermined number of actuations of the input device 18 and discharging of the storage cell(s) using the residual capacity, a further breach of the safety limit is no longer possible. Operation of the vehicle is then possible only until reaching the residual capacity.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for increasing a range of an electric vehicle equipped with an electric motor, at least one storage cell and a controller for the electric motor, the method comprising the steps of:
a) initiating activation of a residual capacity of the storage cell by an operator, wherein use of the residual capacity is blocked in a normal driving mode by the controller; and
b) unlocking the residual capacity.

2. The method as claimed in claim 1, wherein
the activation of the residual capacity in step (a) is initiated by an input of an activation code.

3. The method as claimed in claim 2, wherein the input of the activation code is carried out by entering a key combination.

4. The method as claimed in claim 1, wherein between the steps (a) and (b), the method further comprises the step of:
c) confirming the activation of the residual capacity by the operator.

5. The method as claimed in claim 4, wherein between the steps (a) and (c), the method further comprises the step of:
d) outputting an indication to the operator by the electric vehicle that the activation of the residual capacity of the storage cell can cause damage.

6. The method as claimed in claim 5, wherein between the steps (a) and (c), the method further comprises the step of:
e) outputting an indication to the operator by the electric vehicle that the activation of the residual capacity is logged in a memory and is readable out of the memory.

7. The method as claimed in claim 6, wherein the method further comprises the step of:
f) logging the activation of the residual capacity in the memory.

8. The method as claimed in claim 1, wherein by activating the residual capacity, a complete discharging of the at least one storage cell is made available.

9. The method as claimed in claim 1, wherein the method increases the range of an electric scooter.

10. An electric vehicle, comprising:
an electric motor;
at least one storage cell for powering the electric motor, a residual capacity of the storage cell being unlockable;
a controller that controls the electric motor and is coupled to the at least one storage cell, the controller blocking use of the residual capacity of the at least one storage cell in a normal driving mode of the electric vehicle; and
an input device coupled to the controller, wherein the controller unlocks the use of the residual capacity of the at least one storage cell upon actuation of the input device.

11. The electric vehicle as claimed in claim 10, wherein the electric vehicle is an electric scooter.

12. The electric vehicle as claimed in claim 10, wherein the controller is configured to enable complete discharging of the residual capacity of the at least one storage cell.
